(19) United States
(12) Patent Application Publication
(10) Pub. No.: US 2017/0203901 A1
(43) Pub. Date: Jul. 20, 2017

(54) EASY-OPEN AND RECLOSABLE FLOW WRAP PACKAGE

(71) Applicant: PRINTPACK ILLINOIS ,INC., Elgin, IL (US)

(72) Inventors: Ronald W. KOMRO, Smyrna, GA (US); Edward J. CIGALLIO, Winston, GA (US); Anthony J. ALVAREZ, Atlanta, GA (US); Rajesh SURYANARAYANAN, Powder Springs, GA (US)

(21) Appl. No.: 15/320,879

(22) PCT Filed: Jun. 22, 2015
(86) PCT No.: PCT/US2015/036970

§ 371 Date: Dec. 21, 2016

Related U.S. Application Data
(60) Provisional application No. 62/028,198, filed on Jul. 23, 2014.
(60) Provisional application No. 62/019,415, filed on Jun. 30, 2014.

(51) Int. Cl. B65D 75/58; B65D 85/36; B32B 15/09; B65D 33/00; B32B 7/12; B32B 15/085; B65D 75/38; B65D 33/04

(52) U.S. Cl. CPC B65D 75/5855; B65D 75/38; B65D 85/36; B65D 33/04; B65D 33/004; B32B 7/12; B32B 15/085; B32B 15/09; B65D 2575/586; B32B 2439/70

(57) ABSTRACT

An easy open and reclosable package 110 is provided including a package body formed from a flexible film having a heat sealable inner layer, an outer layer, and a pressure sensitive adhesive disposed between the inner layer and the outer layer. A transverse end seam 118, 120 with a heat seal region 122, 124 is disposed across a transverse end of the package body and has at least a portion of a patterned die cut formed in the heat sealable inner layer therein, so as to allow a portion of the inner layer to delaminate and expose a portion of the pressure sensitive adhesive in the heat seal region when the transverse end seam is opened to form a substantially full opening in the transverse end of the package body. Flexible films and methods for fabrication of the flexible films and packages also are provided.

### CROSS-REFERENCE TO RELATED APPLICATIONS

This application claims priority to U.S. Provisional Application No. 62/019,415, filed Jun. 30, 2014, and U.S. Provisional Application No. 62/028,198, filed Jul. 23, 2014, each of which is incorporated by reference in its entirety.

### BACKGROUND

The present application relates to flexible packaging that is easily opened and reclosed. More particularly, the present application is directed to flexible packaging that can be easily opened to provide full access for removal of a product contained therein.

Flexible packages are widely used for storing items such as various food products. More recently, it has become common to employ reclosing features on flexible packages to allow a consumer to consume a portion of the contents of the package and then reseal the remaining contents of the package for later consumption. Examples of such reclosing features include zippers and interlocking members which allow opposing sides of the packages to be mechanically joined together. Such reclosing features are commonly manufactured in an off-line production process and are later added to the flexible package at a forming or sealing stage. There are many disadvantages with employing such reclosing features, including the associated operating and equipment costs for manufacturing and integrating these features into flexible packages. Alternatively, labels have been introduced to create pull-open resealable packages permitting consumers to open and reseal a package from its top panel rather than its end panel. These packages still suffer from certain disadvantages by not providing consumers with full access to all products contained therein, particularly the products along the edges and corners of the package.

Accordingly, it is desirable to provide new flexible packages that avoid the disadvantages associated with existing reclosable features.

### SUMMARY

Embodiments of the present application address the above-described needs by providing an easy open and reclosable package including a package body formed from a flexible film having a heat sealable inner layer, an outer layer, and a pressure sensitive adhesive disposed between the inner layer and the outer layer. A transverse end seam with a heat seal region is disposed across a transverse end of the package body. At least a portion of a patterned die cut formed in the heat sealable inner layer is disposed in the heat seal region so as to allow a portion of the inner layer to delaminate and expose a portion of the pressure sensitive adhesive in the heat seal region when the transverse end seam is opened to form a substantially full opening in the transverse end of the package body.

In other embodiments, a roll of flexible film and method for its fabrication are provided. The method includes providing a flexible film with a heat sealable inner layer, an outer layer, and a pressure sensitive adhesive disposed between the inner layer and the outer layer; and forming a patterned die cut in the heat sealable inner layer extending laterally across at least a portion of the flexible film, the patterned die cut comprising nested die cuts having a variance of about 1 to about 3 mm to provide a flexible film configured to form an easy open and reclosable package having a transverse end seam with a heat seal region across a transverse end of the package body, at least a portion of the patterned die cut being disposed in the heat seal region so as to allow a portion of the inner layer to delaminate and expose a portion of the pressure sensitive adhesive in the heat seal region when the transverse end seam is opened to form a substantially full opening in the transverse end of the package body.

In still another embodiment, a method of manufacturing an easy open and reclosable package is provided including providing a flexible film having a heat sealable inner layer, an outer layer, and a pressure sensitive adhesive disposed between the inner layer and the outer layer; forming a patterned die cut in the heat sealable inner layer; folding the flexible film about a product and forming a longitudinal seam by joining opposing longitudinal edges of the flexible film; and forming at least one transverse end seam by heat sealing the flexible film to form a transverse heat seal region extending laterally across a transverse edge of the package, the patterned die cut being disposed in the transverse heat seal region.

Additional aspects will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 is a perspective view of an embodiment of an easy open and reclosable package.

FIG. 2 is a plan view of a flexible film used to manufacture the package of FIG. 1.

FIG. 3 is a partial cross-sectional view of a flexible film according to an embodiment.

FIGS. 4A-4N are a schematic illustration of a consumer opening and reclosing an easy open and reclosable package according to an embodiment.

FIG. 5 is a perspective view of an embodiment of an easy open and reclosable package.

### DETAILED DESCRIPTION

Embodiments of the present application are directed generally to an easy open and reclosable package and methods for manufacturing such packages. Although the features described herein are generally made with reference to flow wrapper packaging, those skilled in the art will appreciate that the features also could be used in other types of flexible packaging, including stand-up pouches and the like.

Generally described, an easy open and reclosable package is provided that is formed from a flexible film comprising a heat sealable inner layer, an outer layer, and a pressure sensitive adhesive disposed between the inner layer and the outer layer. One or two transverse end seams comprising a heat seal region may be disposed across one or both transverse ends of the package body. A patterned die cut may be disposed in the heat sealable inner layer, at least a portion of the patterned die cut being disposed in the heat seal region of one of the transverse end seams so as to allow a portion of the inner layer to delaminate and expose a portion of the pressure sensitive adhesive in the heat seal region when the transverse end seam is opened to form a substantially full opening at the transverse end of the package body.

As used herein, a “substantially full opening” means an opening across substantially all of the width of the package body in the transverse direction, and may be characterized as extending across at least about 90% of the width of the package body, at least about 95% of the width of the package body, at least about 98% of the width of the package body, or about 100% of the width of the package body. The term “full access” also is used herein to characterize the accessibility of a package with “a substantially full opening.”

In some embodiments, the package body may include one or more gussets to further facilitate full access to the contents therein. The one or more gussets may be disposed in one or both side panels of the package body (i.e., between the front panel and the back panel), and each generally may include a center fold that divides the gusset into a first folded portion and a second folded portion. The heat seal region may extend across one or both gussets such that the first folded portion is sealed to itself by mating surfaces of the inner layer of the first folded portion and the second folded portion is sealed to itself by mating surfaces of the inner layer of the second folded portion.

The package body may further include one or more additional structural features to facilitate the easy open and reclosable features of the package. For example, in embodiments one or more tabs may be positioned at or near a transverse end of the package body beyond the transverse end seam and heat seal region to facilitate opening of the package.

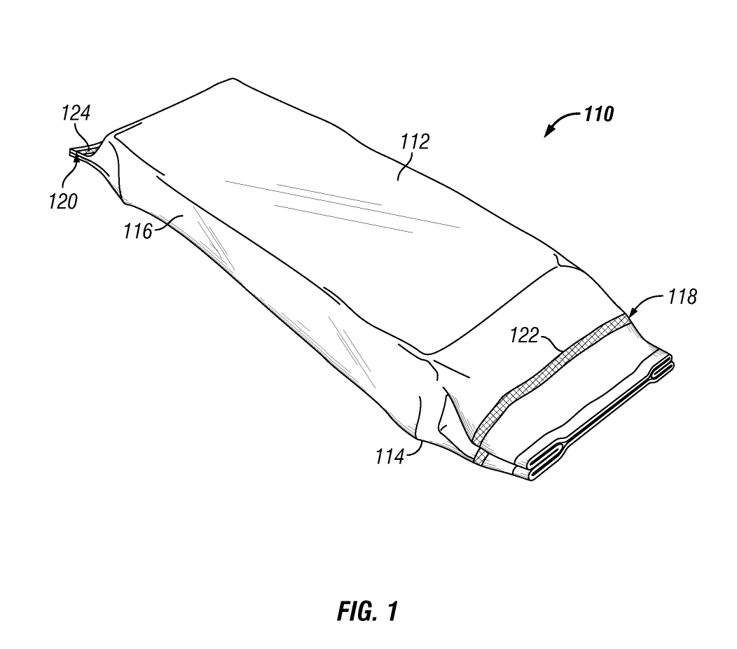

An exemplary embodiment of a package 110 is illustrated in FIG. 1. The package 110 is formed from a continuous web of flexible film 200 with a longitudinal seam (not shown) securing opposing longitudinal ends 210, 212 of the flexible film in a longitudinal direction along the package body 110. The package body 110 includes a front panel 112, back panel 114, and two opposing side panels 116. First 118 and second 120 transverse end seams comprising first 122 and second 124 heat seal regions, respectively, are disposed at the transverse ends of the package body 110, forming a seal between the front panel 112 and back panel 114 of the package body 110.

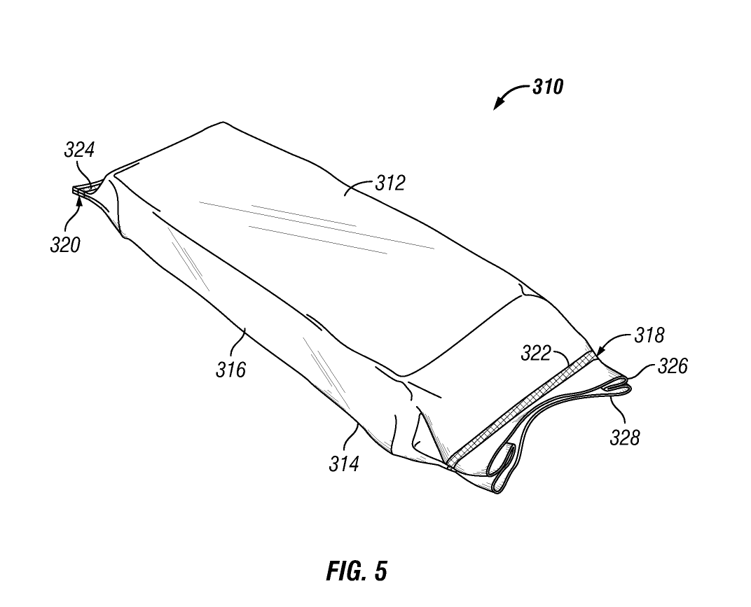

Another exemplary package 310 is illustrated in FIG. 5. The package 310 includes a front panel 312, back panel 314, and two opposing side panels 316. First 318 and second 320 transverse end seams comprising first 322 and second 324 heat seal regions, respectively, are disposed at the transverse ends of the package body 310, forming a seal between the front panel 312 and back panel 314 of the package body 310. Each side panel 316 includes a gusset including a center fold that divides the gusset into a first folded portion 326 and a second folded portion 328. The heat seal region 322 may extend across one or both gussets such that the first folded portion 326 is sealed to itself by mating surfaces of the inner layer of the first folded portion and the second folded portion 328 is sealed to itself by mating surfaces of the inner layer of the second folded portion.

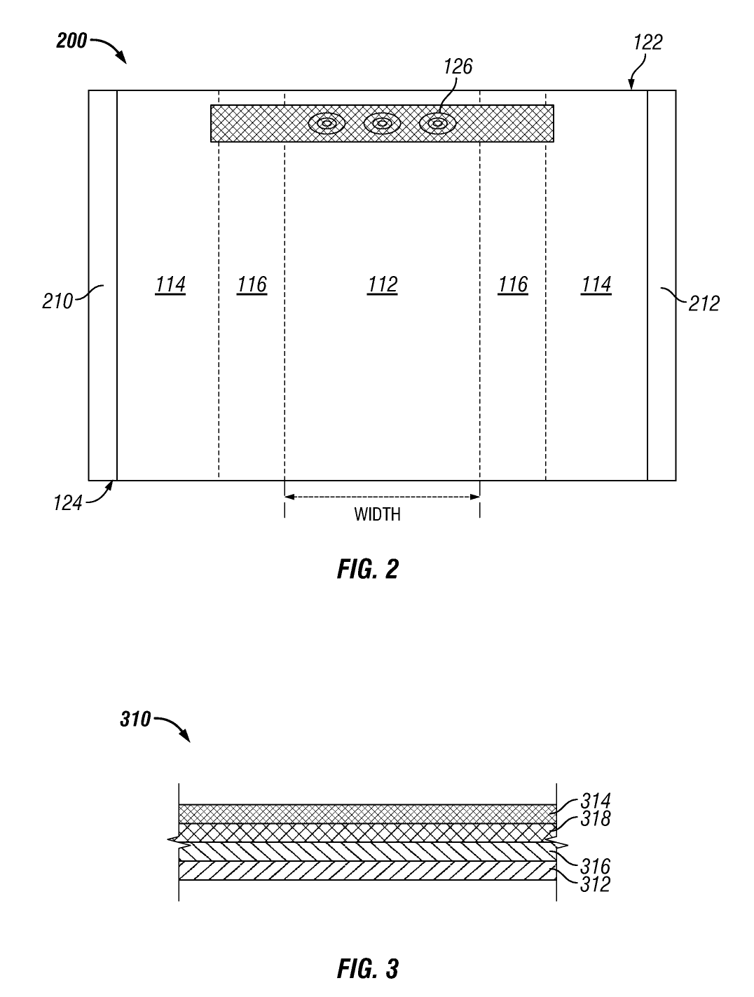

A patterned die cut 126 (e.g., FIG. 2) may be formed in a heat sealable inner layer 312 in the first heat seal region 122 of one of the front panel 112 and back panel 114. The patterned die cut 126 also may extend into, but not through, the pressure sensitive adhesive 316. In embodiments, the patterned die cut 126 is disposed in the first heat seal region 122 of the front panel 112 and extends across at least a portion or substantially all of the width of the package body 110. For example, in embodiments the patterned die cut 126 may extend across at least 40% of the width of the package body 110, at least 50% of the width of the package body 110, at least 75% of the width of the package body 110, about 100% of the width of the package body 110, or amounts therebetween.

The patterned die cut 126 may be a combination of any one of a die cut, score line, perforation line, or other line of weakness that facilitates delamination and separation of the inner layer 312 to expose a pressure sensitive adhesive 316. For example, in embodiments, the patterned die cut 126 comprises a series of two or more nested die cuts. As used herein, the term “nested die cuts” refers to overlapping and/or offset lines of weakness. Generally, nested die cutting involves placing a sequence of similar die cut patterns one inside of the other, with each successive pattern being of a smaller scale than the previous cut, much like a “bulls eye” pattern. For example, the nested die cuts may be formed by 2 to 8 lines of weakness, 2 to 6 lines of weakness, 2 to 5 lines of weakness, 2 to 4 lines of weakness, or 3 to 4 lines of weakness having a variance (measured as the radial distance from one pattern to its adjacent pattern) from about 1 to about 3 mm, from about 1 to about 2 mm, or about 1.5 mm. The lines of weakness may be formed by concentric die cuts of one or more suitable shapes, non-limiting examples of which include ellipses (e.g., circles, ovals, and the like) or polygons (e.g., square, rectangles, triangles, trapezoids, and the like), or partial ellipses or polygons. For example, the patterned die cut 126 in FIG. 2 includes 3 lines of weakness forming of concentric ovals. In addition, the patterned die cut 126 may further comprise machine direction end cuts at one or both ends of the patterned die cut.

A cross-section of an embodiment of a flexible film 310 forming the package body is illustrated in FIG. 3. The flexible film 310 may include a heat sealable inner layer 312, an outer layer 314, and a pressure sensitive adhesive 316 disposed between at least a portion of the inner layer 312 and outer layer 314. Additional layers, such as print, barrier, and adhesive layers, also may be included in the flexible film. For example, the flexible film 310 may include a print layer 318 disposed between the outer layer 314 and the pressure sensitive adhesive 316.

The heat sealable inner layer 312 and outer layer 314 may be formed using the same or different materials, non-limiting examples of which include polymeric materials, metallized polymeric materials, metallic foils, paper-based materials, and combinations thereof. Suitable polymeric materials and metallized-polymeric materials frequently used in packaging applications may include polyolefins (e.g., polyethylenes and polypropylenes), polyamides, and other thermoplastic polymers. These materials may be produced as a cast or blown film and may be subsequently bi-axially or mono-axially oriented. For example, in an embodiment the inner layer may be a polyethylene terephthalate (PET) and the outer layer may be an oriented PET or biaxially-oriented polypropylene. Further functionality may be added by coating the materials by a vacuum deposition, aqueous deposition, spray process, or other means.

In some embodiments, the pressure sensitive adhesive is coextensive with the inner and outer layers. In other embodiments, the pressure sensitive adhesive is pattern applied in the functional region, i.e., the region of the patterned die cut. In such an embodiment, a conventional laminating adhesive may be employed over the remaining area to seal the outer layer and inner layer together. Various pressure sensitive adhesives may be used to form the pressure sensitive adhesive layer, non-limiting examples of which include elastomer compounds with a suitable tackifier (e.g., a rosin ester). Exemplary elastomers include natural rubber, nitriles, butyl rubber, acrylics, styrene block copolymers, vinyl ethers, and ethylene-vinyl acetate. In other embodiments, the pressure sensitive adhesive comprises a permanent adhesive that has been modified to stick to itself. Thus, as used herein, the term “pressure sensitive adhesive” also includes adhesives that are modified to have the same or similar functionality as conventional pressure sensitive adhesives. Methods for such modifications include adjusting the ratio of adhesive compounds in the formulation and application of a kill zone in a particular region. For example, a kill zone may be formed in a select area by applying one or more deadening agents over the desired portion of the adhesive which is intended to be modified. Generally, suitable pressure sensitive adhesives for use in the present application include those having an adhesive strength from about 50 to about 350 g/in or from about 100 to about 300 g/in.

In another aspect, a method of fabricating an easy open and reclosable package is provided. The method may include providing a continuous web of a flexible film comprising a heat sealable inner layer, an outer layer, and a pressure sensitive adhesive disposed between the inner layer and the outer layer; forming a patterned die cut in the heat sealable inner layer; folding the flexible film about a product and forming a longitudinal seam by joining opposing longitudinal edges of the flexible film; and forming at least one transverse end seam by heat sealing the flexible film to form a transverse heat seal region extending across a transverse end of the package.

In embodiments, the patterned die cut may be formed in the heat sealable inner layer using any suitable methods known to those skilled in the art, non-limiting examples of which include using a cutting tool, such as a cutting die, or a laser. The patterned die cut may be applied to the flexible film in off-line or in-line processes with respect to packaging of the product, and also may be formed in both horizontal and vertical form fill seal operations, among others. For example, the patterned die cut may be formed in the flexible film in-line just before the flexible film is formed into a package body, filled with product, and sealed. Alternatively, the patterned die cut may be formed in the flexible film and wound on a reel by a packaging converter and then loaded into the packaging equipment on which it is then unwound and formed into a package body, filled with product, and sealed.

The easy open and reclosable packages provided herein may be used for containing a variety of products, particularly rigid or semi-rigid food products or products contained in a tray about which the flexible film is disposed. For example, the easy open and reclosable packages may be used for food products such as chocolate and sugar confectionary products, nutraceuticals, cookies, crackers, biscuits, and the like. The easy open and reclosable packages are particularly suited for use with products that are contained within trays, such as cookies or biscuits, that a consumer desires to access by at least partially removing the tray from the transverse end of the package body. The easy open and reclosable package also may have applications in other industries, non-limiting examples of which include fertilizers and the like.

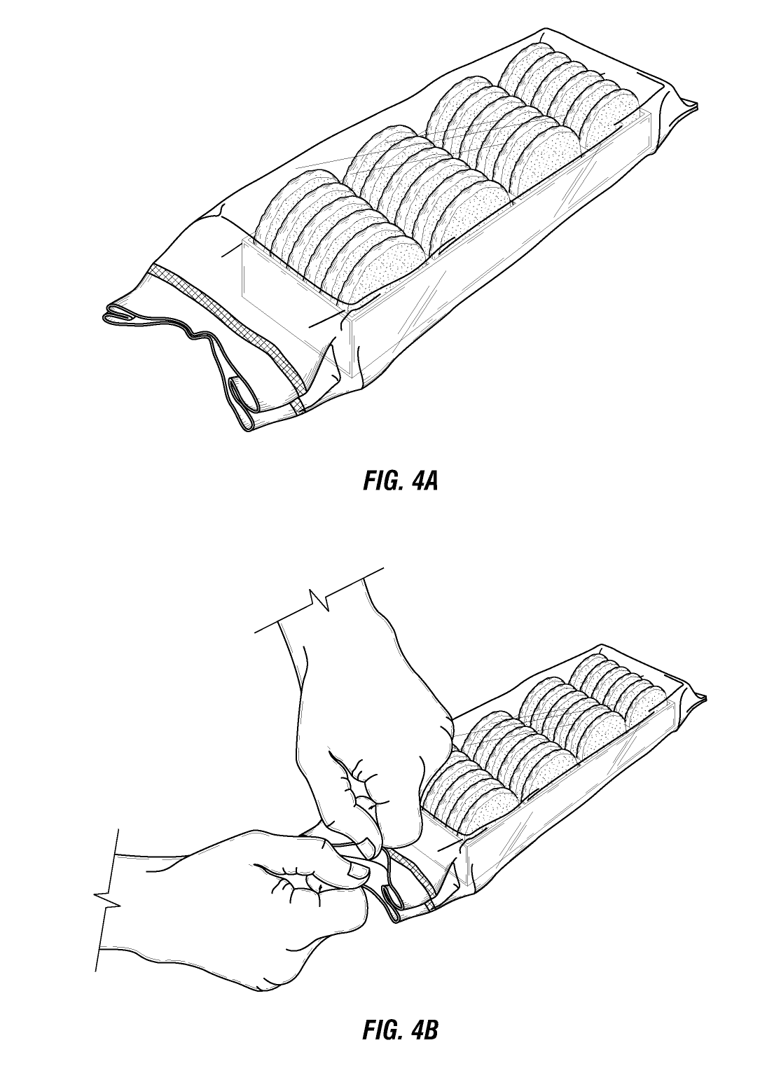

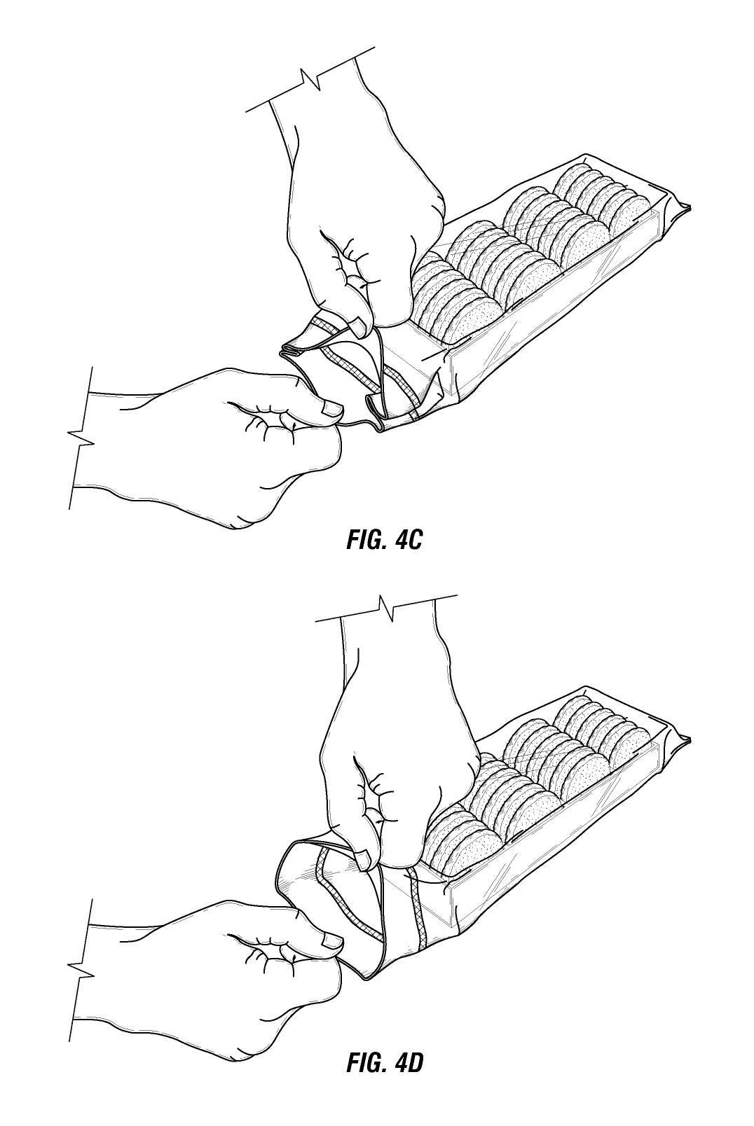

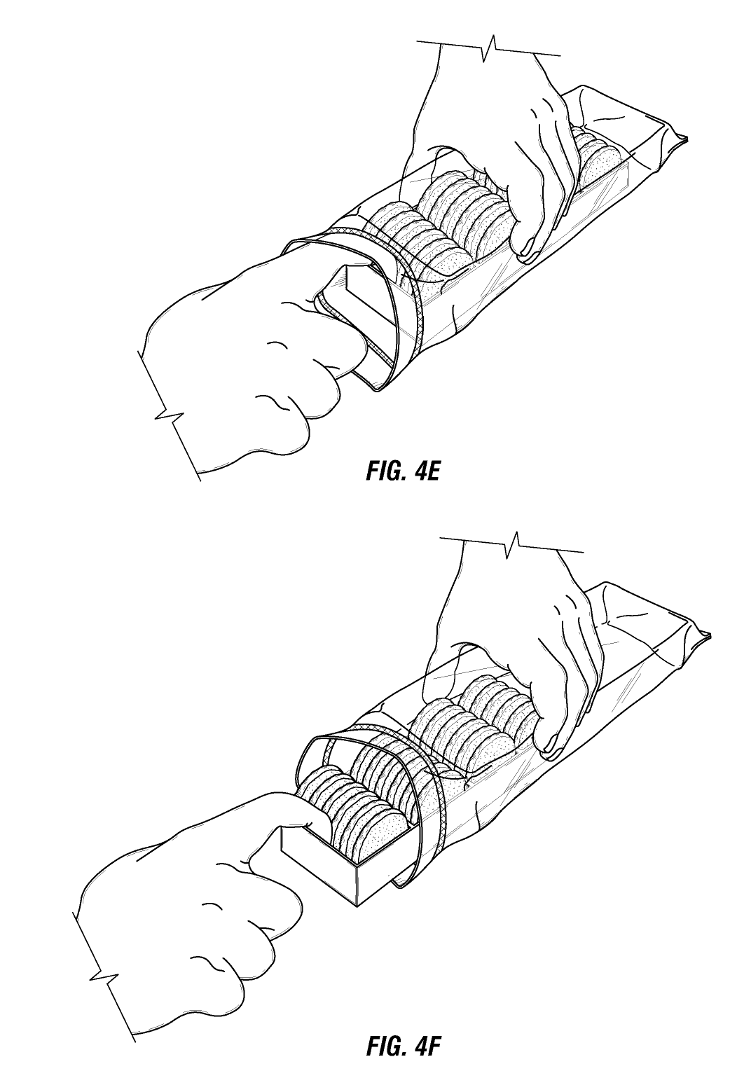

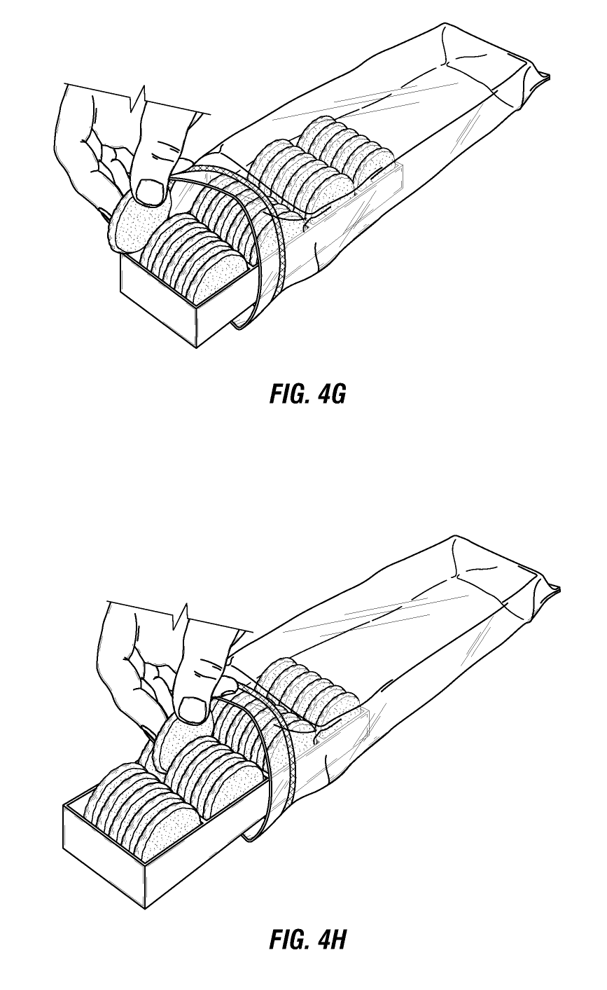

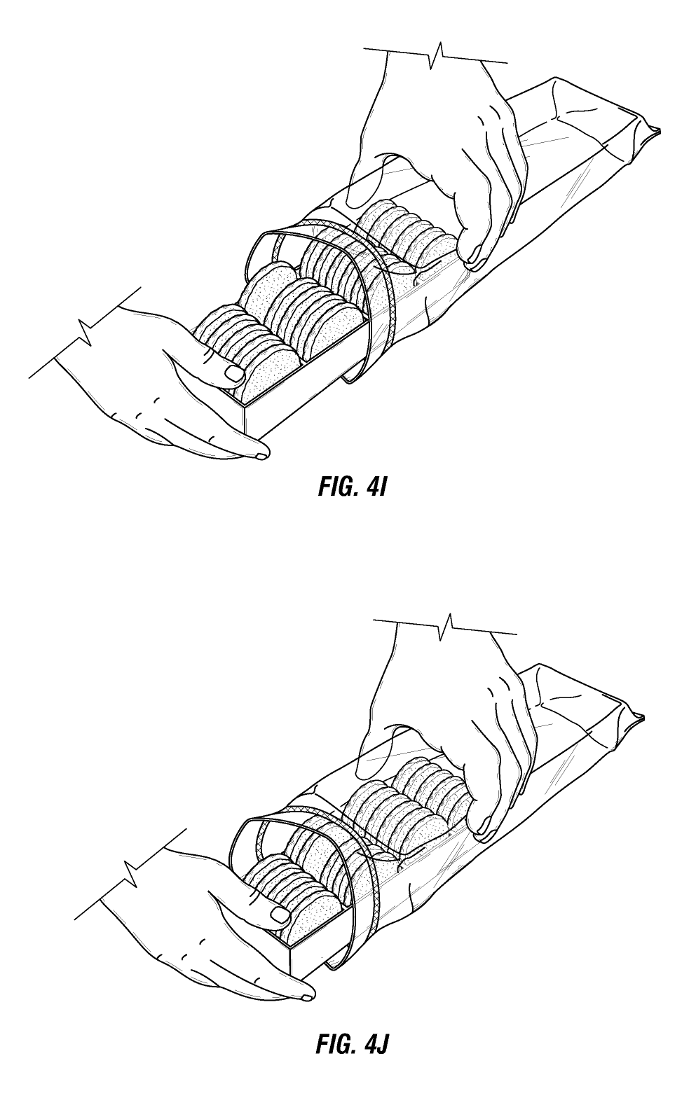

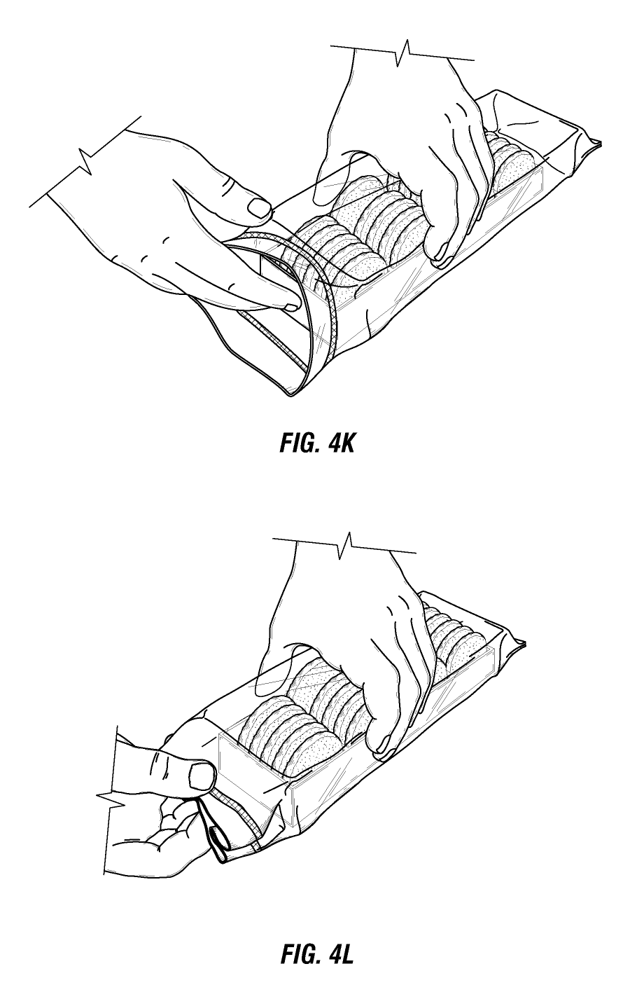

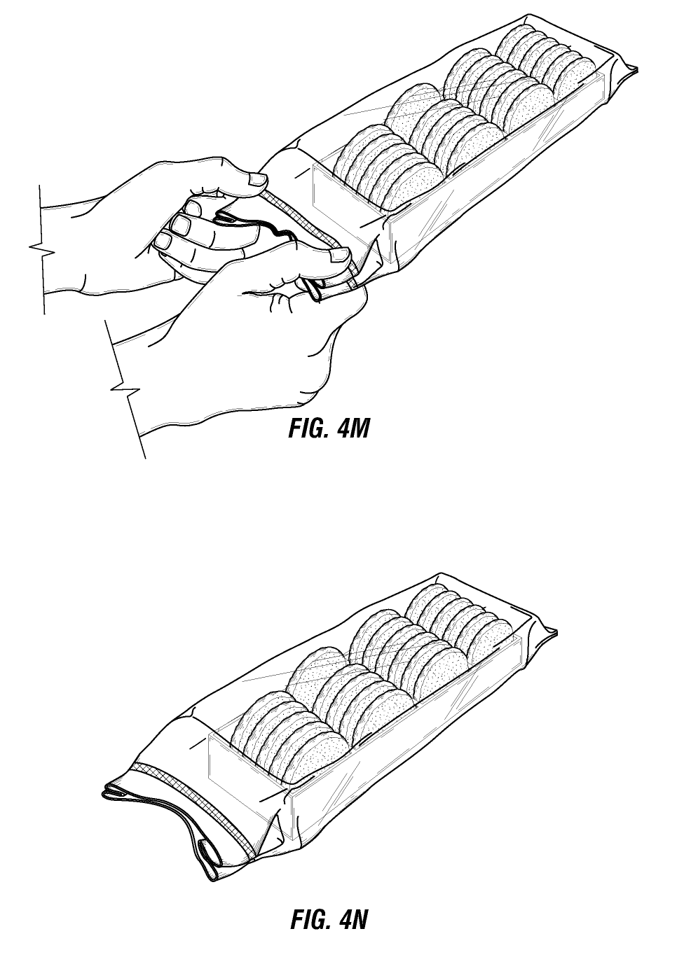

A schematic illustration of an exemplary embodiment of use of an easy open and reclosable package including a confectionary, such as cookies, is illustrated in FIGS. 4A-4N. A consumer may take an unopened package (FIG. 4A) and pull open a transverse end seam by grasping tabs formed by opposing transverse edges of the package (FIGS. 4B-4D) to form a full access opening in the transverse end of the package (FIG. 4E). Once opened, the consumer may partially remove a tray containing the product from the transverse end of the package (FIG. 4F) and remove one or more products from the tray (FIGS. 4G-4H) before pushing the tray back into the package body (FIGS. 4I-4K). After the tray containing the remaining product is returned inside the package body, the consumer may press together the front and back panels of the package along the transverse end (FIG. 4L-4M) to reclose the package (FIG. 4N).

The packaged products may be manufactured using any suitable packaging method, particularly form, fill, and seal methods using rolls of the flexible film having the above-described features. For example, in certain embodiments the method of packaging the product includes providing a roll of a flexible film including a heat sealable inner layer, an outer layer, and a pressure sensitive adhesive disposed between the inner layer and the outer layer, the heat sealable inner layer including a patterned die cut near the transverse edge of the flexible film. The flexible film may then be folded about the product (or tray), a longitudinal seam may be formed by joining opposing longitudinal edges of the flexible film, and two transverse end seams may be formed at opposing transverse edges of the flexible film.

Advantageously, the flexible film may be configured such that the force to open the package from the outside is less than the force to open the package from the inside, thereby providing some protection against the flexible film prematurely opening and exposing the pressure sensitive adhesive. The strength of the package may be manipulated by modifying the position of the patterned die cut relative to the heat seal region and transverse end seam. Thus, a patterned die cut positioned close to the transverse end seam would require less force to open or prematurely burst than a patterned die cut positioned further from the transverse end seam. These features are particularly suited for packages that are shipped across altitude (e.g., over the mountains).

In certain embodiments, a roll of a continuous web of a flexible film is provided having a heat sealable inner layer, outer layer, and a pressure sensitive adhesive disposed between the inner layer and the outer layer, a patterned die cut being disposed in at least the heat sealable inner layer. The roll may be suitable for forming a plurality of packages, and may include one or more additional lines of weakness to facilitate easy separation of the flexible film for the package body from the roll of flexible film that is supplied. For example, the roll of flexible film may be fed through a machine which folds it about each product in turn so that opposing longitudinal edges are brought into contact and bonded together to form a longitudinal seam. The flexible film may then be crimped or bonded at opposing ends of the product to form the transverse end seams, and the flexible film may be cut to separate each packaged product from the remainder of the roll of flexible film.

Although the foregoing embodiments describe packaging including a longitudinal seam or which is formed using a flow-wrap process, the description should not be construed as limiting the easy open and reclosable packages to such structures. For example, the easy open and reclosable packages could be formed with seams along one or both of the longitudinal sides of the package instead of or in addition to the longitudinal seam.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

1. An easy open and reclosable package comprising:
a package body formed from a flexible film comprising a heat sealable inner layer, an outer layer, and a pressure sensitive adhesive disposed between the inner layer and the outer layer;
a transverse end seam comprising a heat seal region across a transverse end of the package body; and
a patterned die cut formed in the heat sealable inner layer, at least a portion of the patterned die cut being disposed in the heat seal region so as to allow a portion of the inner layer to delaminate and expose a portion of the pressure sensitive adhesive in the heat seal region when the transverse end seam is opened to form a substantially full opening in the transverse end of the package body.

2. The package of claim 1, wherein the patterned die cut comprises nested die cuts.

3. The package of claim 2, wherein the nested die cuts comprise from 2 to 8 lines of weakness.

4. The package of claim 2, wherein the nested die cuts comprise from 3 to 4 lines of weakness.

5. The package of claim 1, wherein the heat seal region forms a seal between a front panel and a back panel of the package body at the transverse end seam.

6. The package of claim 5, wherein the patterned die cut is disposed in the heat seal region of one or both of the front panel and back panel.

7. The package of claim 5, wherein the patterned die cut is disposed only in the heat seal region of the front panel.

8. The package of claim 1, wherein the patterned die cut extends across at least 40% of the transverse end of the package body.

9. The package of claim 8, wherein the patterned die cut further comprises machine direction end cuts at one or both ends of the patterned die cut.

10. The package of claim 1, wherein the patterned die cut extends through the inner layer and into a portion of the pressure sensitive adhesive.

11. The package of claim 1, the package body further comprising at least one gusset.

12. The package of claim 11, wherein the at least one gusset has a center fold that divides the gusset into a first folded portion and a second folded portion.

13. The package of claim 12, wherein the heat seal region extends across the gusset such that the first folded portion is sealed to itself by mating surfaces of the inner layer of the first folded portion and the second folded portion is sealed to itself by mating surfaces of the inner layer of the second folded portion.

14. The package of claim 1, wherein the flexible film further comprises a print layer disposed between the outer layer and the pressure sensitive adhesive.

15. The package of claim 1, wherein the flexible film further comprises a permanent adhesive layer disposed between the outer layer and the pressure sensitive adhesive.

16. The package of claim 14, wherein the pressure sensitive adhesive comprises a patterned layer disposed in at least a portion of the heat seal region.

17. The package of claim 1, the package body further comprising at least one longitudinal seam securing two opposing longitudinal ends of the flexible film in a longitudinal direction along the package body.

18. The package of claim 1, further comprising a tray containing a product therein about which the flexible film is disposed.

19. A roll of flexible film for forming the easy open and reclosable package of claim 1.

20. A method of fabricating a flexible film comprising:
providing a flexible film comprising a heat sealable inner layer, an outer layer, and a pressure sensitive adhesive disposed between the inner layer and the outer layer; and
forming a patterned die cut in the heat sealable inner layer extending laterally across at least a portion of the flexible film, the patterned die cut comprising nested die cuts having a variance of about 1 to about 3 mm,
wherein the flexible film is configured to form an easy open and reclosable package having a transverse end seam comprising a heat seal region across a transverse end of the package body, at least a portion of the patterned die cut being disposed in the heat seal region so as to allow a portion of the inner layer to delaminate and expose a portion of the pressure sensitive adhesive in the heat seal region when the transverse end seam is opened to form a substantially full opening in the transverse end of the package body.

21. A method of manufacturing an easy open and reclosable package comprising:
providing a flexible film comprising a heat sealable inner layer, an outer layer, and a pressure sensitive adhesive disposed between the inner layer and the outer layer;
forming a patterned die cut in the heat sealable inner layer, the patterned die cut comprising nested die cuts extending laterally across at least a portion of the flexible film;
folding the flexible film about a product and forming a longitudinal seam by joining opposing longitudinal edges of the flexible film; and
forming at least one transverse end seam by heat sealing the flexible film to form a transverse heat seal region extending laterally across a transverse edge of the package, the patterned die cut being disposed in the transverse heat seal region.
